(19) United States
(12) Patent Application Publication
(10) Pub. No.: US 2015/0301991 A1
(43) Pub. Date: Oct. 22, 2015

(54) WEBAPP STARTUP METHOD AND DEVICE

(71) Applicant: Tencent Technology (Shenzhen) Company Limited, Shenzhen City, (CN)

(72) Inventors: Zhiqiang HE, Shenzhen (CN); Qi LI, Shenzhen (CN); Liang MA, Shenzhen (CN)

(21) Appl. No.: 14/405,911

(22) PCT Filed: Jun. 6, 2013
(86) PCT No.: PCT/CN2013/076842

§ 371 Date: Dec. 5, 2014

(30) Foreign Application Priority Data
Jun. 8, 2012 (CN) 201210188679.2

(51) Int. Cl. G06F 17/22; G06F 3/0484

(52) U.S. Cl. CPC G06F 17/2247; G06F 3/0484

(57) ABSTRACT

The present invention provides a Web Application (WebApp) startup method and device and relates to the filed of computer. The method comprises: receiving a WebApp startup command from a user; retrieving and running HTML codes corresponding to the WebApp; retrieving a startup mode for the WebApp through the HTML codes; running a full-screen display meta label in the HTML codes when the user starts up the WebApp by a pre-established WebApp shortcut on a main screen of a terminal. In the present invention, a pre-established WebApp shortcut on a main screen of a terminal starts up the WebApp with full screen display, and users can access the WebApp without inputting a web address, which enables a WebApp to maintain the features of good compatibility, convenience, no installlation, and also to achieve the same operability and display effect with a Native Application (NativeApp).

This application claims the priority of Chinese Patent Application No. 201210188679.2, filed on Jun. 8, 2012 in the State Intellectual Property Office of China, the disclosure of which is incorporated by reference herein in their entirety for all intended purposes.

### TECHNICAL FIELD

The present disclosure relates generally to method and apparatus for launching a WebApp.

### BACKGROUND

WebApp (Webpage Application) refers to Web based systems and applications, which function to provide a set of complicated contents and functions to terminal user. WebApp ranges, for example, from a webpage for helping customers calculate the fee for renting a car to a large website for providing various types of travel services to business men and travelers. A user may access and use the WebApp by simply inputting the website address in a browser. Recently, with the development of Hypertext Markup Language 5 (HTML 5), functions of WebApp become more powerful with the help of some new elements and attributes provided by HTML 5.

NativeApp (Native or local Application) is located above the platform layer of a terminal. A user may acquire a Native App through a download platform. The NativeApp may be software installed in the terminal. For example, based on the mobile platform of Apple™, the user may select his/her favorite application in the App store, download and install it locally. After the installation, a shortcut is created on the main screen for the installed application, and the user may enter the application by clicking at any time.

WebApp and NativeApp are two ways for providing application currently in a terminal, especially in a mobile terminal. WebApp can be accessed via a browser, and thus possesses advantages of good compatibility, convenience, and no need for installation. Most of NativeApps are developed for particular platforms and thus have better flexibility.

However, as class application of HTML 5 has to run within the browser, the WebApp developed based on HTML 5 may be restricted by the browser, for example, it is incapable of displaying in full-screen, the user must input the website address of the WebApp to access, etc. Such restrictions make the operability and display effect of WebApp not as good as that of NativeApp.

### SUMMARY

In order to at least solve the problem of poor operability and display effect of WebApp as compared to NativeApp, a WebApp launch method and apparatus are provided in the embodiments of the disclosure. The proposed technical solutions are as follows.

According to an aspect of the disclosure, a WebApp launch method is provided including:

receiving an instruction from a user for launching a WebApp;

acquiring and running HTML codes corresponding to the WebApp;

acquiring a WebApp launch mode for the user from the HTML codes; and

running a meta label for full-screen display in the HTML codes if the WebApp launch mode for the user is via a WebApp shortcut created previously on a main screen of a terminal,

wherein the meta label is configured to indicate hiding a tool bar and a menu bar of a browser, and to scale the WebApp's frame to the same size as a screen of the terminal.

According to another aspect of the disclosure, a WebApp launch apparatus is provided including:

a receiving module, configured to receive an instruction from a user for launching a WebApp;

a code acquisition module, configured to acquire and run HTML codes corresponding to the WebApp;

a launch mode acquisition module, configured to acquire a WebApp launch mode for the user from the HTML codes; and

a first running module, configured to run a meta label for full-screen display in the HTML codes if the WebApp launch mode for the user is via a WebApp shortcut created previously on a main screen of a terminal,

wherein the meta label is configured to indicate hiding a tool bar and a menu bar of a browser, and to scale the WebApp's frame to the same size as a screen of the terminal.

The technical solutions provided in the embodiments of the disclosure provide the following benefits and advantages: by launching the WebApp and displaying the WebApp in full-screen via the shortcut created previously on the main screen of the terminal, the user can access the WebApp without inputting a website address, which enables the WebApp to achieve the same operability and display effect as the NativeApp, while maintaining the intrinsic features of good compatibility, convenience, and no need for installation.

### DESCRIPTION OF THE DRAWINGS

To illustrate the technical solutions in the embodiments of the present disclosure more clearly, the drawings for describing the embodiments of the disclosure will be briefly introduced in the following. Apparently, the drawings described in the following show merely some embodiments of the present disclosure, and persons of ordinary skill in the art may still derive other drawings from these drawings without inventive efforts.

FIG. 1 is a flow chart of a method for launching WebApp in accordance with Embodiment 1 of the present application;

FIG. 2 is a flow chart of a method for launching WebApp in accordance with Embodiment 2 of the present application;

FIG. 3 is a schematic of an apparatus for launching WebApp in accordance with Embodiment 3 of the present application;

FIG. 4 is a schematic of another apparatus for launching WebApp in accordance with Embodiment 3 of the present application;

FIG. 5 is a schematic of a building module of an apparatus for launching WebApp in accordance with Embodiment 3 of the present application;

FIG. 6 is a schematic of a building module of another apparatus for launching WebApp in accordance with Embodiment 3 of the present application;

FIG. 7 is a schematic of another apparatus for launching WebApp in accordance with Embodiment 3 of the present application;

FIG. 8 is a schematic of another apparatus for launching WebApp in accordance with Embodiment 3 of the present application;

FIG. 9 is a schematic of another apparatus for launching WebApp in accordance with Embodiment 3 of the present application;

FIG. 10 is a schematic of a terminal device in accordance with the embodiments of the present application;

### DETAILED DESCRIPTION OF EMBODIMENTS

To better illustrate the purposes, technical solutions and advantages of the present disclosure, embodiments of the present disclosure will be further described in detail with reference to the drawings in the below.

### Embodiment 1

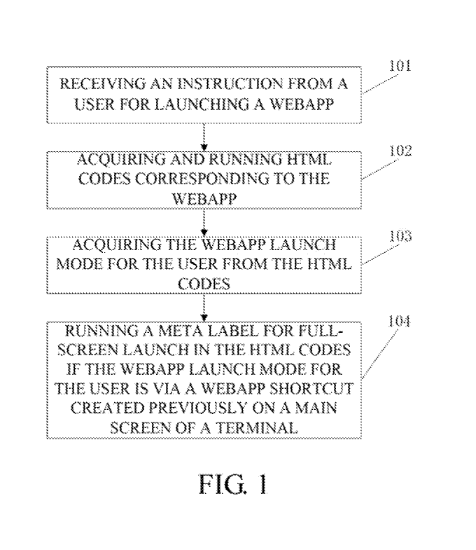

As shown in FIG. 1, a WebApp launch method is provided in this embodiment, which can be implemented by changing the codes corresponding to the WebApp so that the user can access the WebApp in an altered process. The method includes following steps:

101, receiving an instruction from a user for launching a WebApp;

102, acquiring and running HTML codes corresponding to the WebApp;

103, acquiring a WebApp launch mode for the user from the HTML codes;

104, running a meta label for full-screen launch in the HTML codes if the

WebApp launch mode for the user is via a WebApp shortcut created previously on a main screen of a terminal.

Here the meta label is used to indicate hiding a tool bar and a menu bar of a browser, and to scale the WebApp's frame to the same size as a screen of the terminal. The embodiment provides a WebApp launch method, which the WebApp and displays the WebApp in full-screen via the shortcut created previously on the main screen of the terminal. Thereby, the user can access the WebApp without inputting a website address, which enables the WebApp to achieve the same operability and display effect as the NativeApp, while maintaining the intrinsic advantages of good compatibility, convenience, and no need for installation.

### Embodiment 2

A WebApp launch method is provided in this embodiment, which can be implemented by changing the codes corresponding to the WebApp so that the user can access the WebApp in an altered process. Thus, the user experience of the WebApp can be improved without changing the terminal or browser used by the user.

This embodiment is illustrated, for example, under Apple's mobile system, and the used terminal may be for example iPhone or iPad, and the browser may be for example Safari.

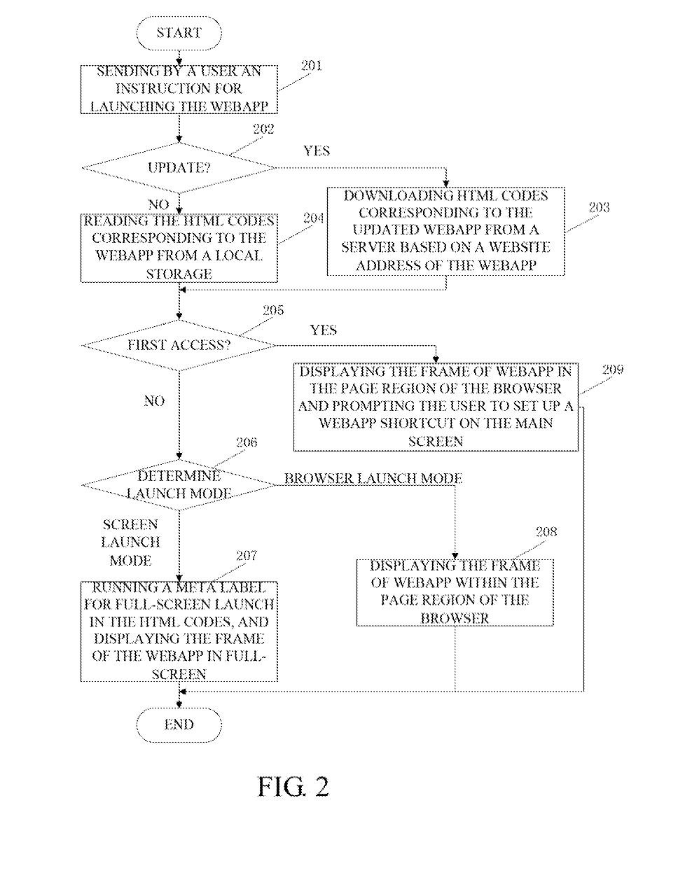

Referring to FIG. 2, a WebApp launch method is illustrated. The method includes following steps:

201, sending, by a user, an instruction for launching the WebApp;

202, determining whether the HTML codes corresponding to the WebApp need to be updated, if so, perform step 203, otherwise, perform step 204;

203, downloading HTML codes corresponding to the updated WebApp from a server, based on a website address of the WebApp, and then jumping to step 205;

204, reading the HTML codes corresponding to the WebApp from a local storage, and then performing step 205;

It is to be noted that, for speeding up the access speed for the WebApp or saving network traffic, the HTML codes corresponding to the WebApp may be optionally saved into the local storage in the terminal after a first run of the WebApp. When the user access the WebApp another time, the HTML codes corresponding to the WebApp can be directly read if the WebApp does not need to be upgraded or updated.

205, running the HTML codes corresponding to the WebApp, and determining whether it is the user's first time of accessing the WebApp, if not, perform step 206, otherwise, perform step 209;

The step of determining whether it is the user's first time of accessing the WebApp may include:

reading a predefined identifier in the local storage, and determining whether it is the user's first time of accessing the WebApp based on the identifier. For example, if the predefined identifier is “firstEnterGame”, it is determined that it is the user's first time of accessing the WebApp; while if the predefined identifier is “false”, it is determined that it is not the user's first time of accessing the WebApp.

Further, after the user's first access of the WebApp, the identifier can be written into the local storage in the browser. This can be implemented by the following codes:

window.localStorage.setItem(“firstEnterGame”, “false”);

When entering the WebApp at next time, the identifier will firstly be read from the local storage and it is determined if the user has read beginner tips, if so, the tips will not be displayed; otherwise, the beginner tips need to be displayed to the user to show how to add a desktop shortcut for the WebApp.

In particular, the step of determining whether the beginner tips need to be shown to the user can be implemented by the following codes:

var isFirstEnterGame=window.localStorage.getItem(“firstEnterGame”).

206, determining a WebApp launch mode for the user by running the HTML codes, if the launch mode is a screen launch mode, performing step 207; if the launch mode is a browser launch mode, performing step 208;

It is to be noted that the user may launch the WebApp in two modes in the present embodiment.

The first mode is the screen launch mode, which may be such that the user launches the WebApp by a WebApp shortcut created previously on a main screen of a terminal.

The second mode is the browser launch mode, which may be such that the user launches the WebApp by inputting a website address corresponding to the WebApp.

Furthermore, the step of determining the user's WebApp launch mode by running HTML codes may include:

sending a request of acquiring the WebApp launch mode to the operation system of the terminal, and obtaining the WebApp launch mode for the user from the response returned by the operation system.

In particular, the WebApp launch mode may be acquired from the operation system by calling a function getItem( ) in the HTML codes corresponding to the WebApp.

207, running a meta label for full-screen launch in the HTML codes, and displaying the frame of the WebApp in full-screen, then the process is ended.

It is to be noted that, the HTML codes contain the meta label for full-screen display. The browser may analyze the meta label to display the frame of WebApp based on the effects set in the meta label. The meta label includes at least a label that indicates hiding a tool bar and a menu bar of the browser, and a label for scaling the WebApp's frame to the same size as the screen of the terminal.

By the meta label for full-screen launch in the HTML codes, the frame of the WebApp on the terminal may be displayed in full-screen, which makes the WebApp achieve the same experience effect as a NativeApp.

In the embodiment, the settings in the meta label may include:

1. setting the tool bar and menu bar of the browser as hidden:

<meta name=“apple-mobile-web-app-capable” content=“yes” />

By setting the value of “apple-mobile-web-app-capable” as “yes” in the meta label, the tool bar and menu bar of the browser can be hidden.

2. setting the startup frame of the WebApp:

<link rel=“apple-touch-startup-image” href=“img/splash.png” />

Here “img/splash.png” is the address of picture of the startup frame. In order to place the startup frame in full-screen, the size of the startup frame should be the same as the size of the terminal screen. For example, the size of the startup frame on iPhone should be set as 320 px*460 px, and the size of the startup frame on iPad should be set as 1024 px*768 px.

3. setting the status bar:

It is to be noted that the status bar is not a component of the browser in the Apple platform. The operation system of Apple requires by default showing the status bar so that the user can see the battery energy of the terminal, the wireless signal strength, etc. Therefore, the status bar can be set in any of three ways:

(1) setting the status bar as transparency, such that the user can see a full-screen WebApp.

<meta name=“apple-mobile-web-app-status-bar-style” content=“black-translucent” />

Here “apple-mobile-web-app-status-bar-style” is used for setting the display effect of the status bar. If it is set as “black-translucent”, the status bar is displayed as transparency.

(2) setting the status bar with an effect of the grey gradient:

<meta name=“apple-mobile-web-app-status-bar-style” content=“default” />

wherein the “apple-mobile-web-app-status-bar-style” is set as “default”.

(3) setting the status as black:

<meta name=“apple-mobile-web-app-status-bar-style” content=“black” />

wherein the “apple-mobile-web-app-status-bar-style” is set as “black”, which is same as the above two setting ways. Generally, it is the preferred option in order for the user to see the status of the terminal at any time.

208, displaying the frame of WebApp within the page region of the browser, then the operation will be ended.

It is to be noted that, if the user runs WebApp through the browser launch mode, it is default to display the frame of WebApp within the page region of the browser instead of full-screen, so as to provide well experience for the user.

Alternatively, if the user desires to display the WebApp in full-screen manner under any launch mode, the step 208 can make the frame of WebApp display in full-screen, referring to step 207.

Alternatively, in order to display within the page region of the browser the entire frame of the WebApp without any blind angle, the method may further include:

controlling the scaling of the frame of WebApp by setting the meta label in the HTML codes corresponding to the WebApp.

In particular, the meta label may inform the terminal of the following information: the hight, width, minimum scale value, maximum scale value, and the initial scale value of the frame of WebApp, and the permission of scaling up and scaling down.

(1) the meta label for scaling control of the frame of the WebApp, by taking iPad as an example, can be:

<meta name=“viewport” content=“width=device-width, initial-scale=2.3, user-scalable=no” />

or,

<meta name=“viewport”content=“width=device-width, initial-scale=2.3, minimum-scale=1, maximum-scale=5” />

wherein, the “device-width” is the width of the display region of the browser page of iPad.

It is to be noted that, the “viewport” in the meta label is a virtual viewport in which the WebApp is fitted, i.e., the page region for displaying WebApp in the browser. Regarding the browser, the viewport is the page region besides all the tool bar, status bar and scrollbar. The controllable attributes in the viewport may include: width—the width of the viewport, height—the height of the viewport, initial-scale—the initial scale ratio of the viewport (ranges from 0 to 10), minimum-scale—the allowable minimum scale ratio of viewport, maximum-scale—the allowable maximum scale ratio of viewport, and User-scale which defines whether the user may perform the scaling operation.

Regarding the above attributes of viewport, the below lists some available options:

width—Width of viewport in pixels, Default: 980, Range: 200-10000;

height—Height of viewport in pixels, Default: calculated with the width and aspect ratio, Range: 223-10000;

initial-scale—The initial scale ratio of the viewport, Default value: calculated to fit the area of the page region of the browser, Range: calculated with minimum-scale and maximum-scale properties;

minimum-scale—The minimum scale of viewport, Default: 0.25, Range:>0-10;

maximum-scale—The maximum scale of viewport, Default: 1.6, Range: 0-10; user-scalable—Whether the user can zoom in and out, Default: yes, Options: yes or no.

(2) the meta label for scaling control of the frame of the WebApp, by taking iPhone as an example, can be:

<meta name=“viewport” content=“width=device-width, initial-scale=1.0, minimum-scale=1.0, maximum-scale=1.0, user-scalable=no” />

wherein, the “device-width” is the width of the display region of the browser of iPhone.

Regarding the above attributes of viewport on iPhone, the below lists some available options:

width—Width of viewport in pixels, Default: 980, Range: 200-10000;

height—Height of viewport in pixels, Default: calculated with the width and aspect ratio, Range: 223-10000;

initial-scale—The initial scale ratio of the viewport, Default value: calculated to fit the area of the page region of the browser, Range: calculated with minimum-scale and maximum-scale properties;

minimum-scale—The minimum scale of viewport, Default: 0.25, Range: >0-10;

maximum-scale—The maximum scale of viewport, Default: 1.6, Range: 0-10;

user-scalable—Whether the user can zoom in and out, Default: yes, Options: yes or no.

209, displaying the frame of WebApp in the page region of the browser, and prompting the user to set up a WebApp shortcut on the main screen, then the operation will be ended.

Further, step 209 may include setting the title, icon, display effect, etc, for the shortcut in the codes, in order to set up a WebApp shortcut on the main screen.

In the present embodiment, the step 209 may be specifically implemented as:

(1) setting a title for the shortcut of the WebApp

the process is to set the title displayed on the main screen and the status bar that correspond to the WebPage by changing the title label, which is specifically illustrated as follows:

<!--Page Title-->

<title >Happy Fighting Landlorder</title> //used for setting the title

<meta http-equiv=“Content-Type” content=“text/html; charset=UTF-8” />

The above meta label is used for setting the Graphical Word Encoding Charset.

In the present embodiment, the UTF-8 standard is applied.

(2) setting the icon of the shortcut:

firstly, setting the size of the icon. For example, if the icon is displayed at the main screen of the iPad, then this icon may be set as 114*114;

secondly, setting the display effect of the icon. There are two setting options for the icon.

One is to add rounded corners for the icon, specifically:

<link rel=“apple-touch-icon-precomposed” href=“img/icon.png” />

the other is to set the luster of the icon, specifically:

<link rel=“apple-touch-icon” href=“img/icon.png” />

Alternatively, before prompting the user to set up a shortcut, the embodiment further includes:

determining whether the currently used browser support the functionality of creating a WebApp shortcut on the main screen. If so, then prompting the user to set up a shortcut and calling an interface of the browser for creating shortcut to set up a WebApp shortcut; otherwise, the step of prompting the user to set up a shortcut is skipped.

In the present embodiment, the Safari browser is preferred. The detailed determination method is as follows:

sending to a browser a request for the title of the browser, and determining if the current browser is the Safari browser based on the browser returned response message.

In the present embodiment, the function window.navigator.userAgent is used to acquire the browser returned response message. If the response message includes Safari, it is determined that the current browser is Safari browser.

The present embodiment provides a WebApp launch method, which launches the WebApp and displays the WebApp in full-screen via the shortcut created previously in the main screen of the terminal. Thereby, the user can access the WebApp without inputting a website address, which enables the WebApp to achieve the operability and display effect same as the NativeApp, while maintaining the advantages of good compatibility, convenience, and no need for installation.

### Embodiment 3

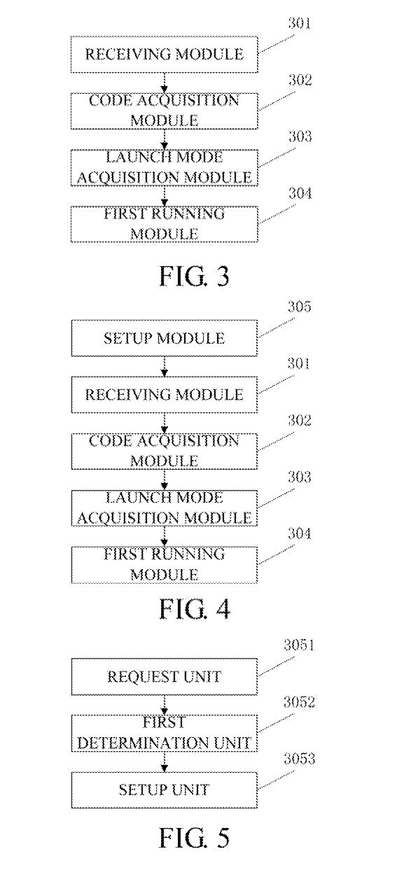

Referring to FIG. 3, the present embodiment of the disclosure provides a WebApp launch apparatus. The apparatus includes:

a receiving module 301, configured to receive an instruction from a user for launching a WebApp;

a code acquisition module 302, configured to acquire and run the HTML codes corresponding to the WebApp;

a launch mode acquisition module 303, configured to acquire a WebApp launch mode for the user from the HTML codes ;

a first running module 304, configured to run a meta label for full-screen launch in the HTML codes if the WebApp launch mode for the user is via a WebApp shortcut created previously on a main screen of a terminal,

wherein the meta label is used to indicate hiding a tool bar and a menu bar of a browser, and to scale the WebApp's frame to the same size as a screen of the terminal.

Alternatively, as shown in FIG. 4, the apparatus may further include:

a setup module 305, configured to set up a WebApp shortcut on the main screen of the terminal before the receiving module 301 receives the instruction from the user for launching the WebApp.

In a further step, as shown in FIG. 5, the setup module 305 may specifically include:

a request unit 3051, configured to send to the browser a request for the title of the browser;

a first determination unit 3052, configured to determine if the current browser is a predefined first browser based on the browser returned response message;

a setup unit 3053, configured to set up a WebApp shortcut on the main screen of the terminal through the browser if the first determination unit 3052 determines that the browser is the predefined first browser;

wherein, the first browser is a browser capable of creating WebApp shortcut.

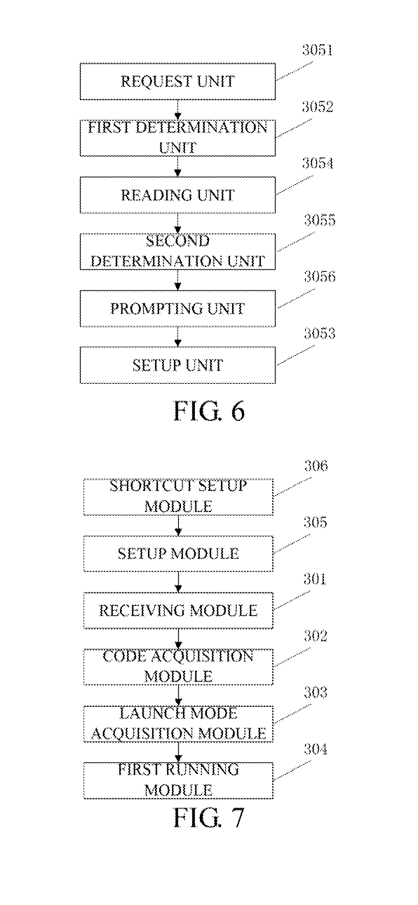

In a further step, as shown in FIG. 6, the setup module 305 may include:

a reading unit 3054, configured to read the flag in the local storage before the setup unit sets up a WebApp shortcut on the main screen of the terminal through the browser, the flag is used to identify whether it is the user's first time of accessing the WebApp;

a second determination unit 3055, configured to determine if it is the user's first time of accessing the WebApp based on the flag;

a prompting unit 3056, configured to prompt the user to create the WebApp shortcut on the main screen of the terminal if the second determination unit 3055 determines that it is the user's first time of accessing the WebApp.

Alternatively, as shown in FIG. 7, the apparatus may further include:

a shortcut setup module 306, configured to set the title, icon, display effect, etc, for the shortcut in the HTML codes before the setup module 305 creates the shortcut of the WebApp on the main screen of the terminal.

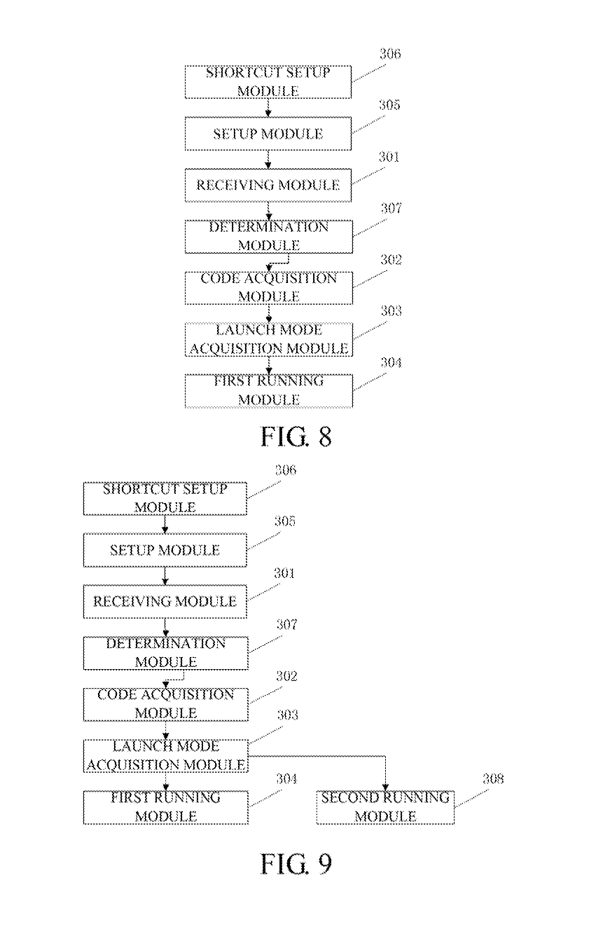

Alternatively, as shown in FIG. 8, the apparatus may further include:

a determination module 307, configured to determine whether the HTML codes corresponding to the WebApp need to be updated before the code acquisition module 302 acquires and runs the HTML codes corresponding to the WebApp.

In a further step, the code acquisition module 302 includes:

a first acquisition unit, configured to acquire the updated HTML codes via the corresponded website address of the WebApp and run the updated HTML codes if the determination module 307 determines that the HTML codes corresponding to the WebApp need to be updated;

a second acquisition unit, configured to read the HTML codes corresponding to the WebApp from the local storage and run the HTML codes corresponding to the WebApp if the determination module 307 determines that the HTML codes corresponding to the WebApp do not need to be updated.

Alternatively, as shown in FIG. 9, the apparatus may further include:

a second running module 308, configured to display the frame of the WebApp within the page region of the browser, based on the scaling control label preset in the HTML codes, if the WebApp launch mode for the user obtained by the launch mode acquisition module 303 is to access WebApp by inputting the website address through the browser.

The present embodiment provides a WebApp launch apparatus, which launches the WebApp and displays the WebApp in full-screen via the shortcut created previously in the main screen of the terminal. Thereby, the user can access the WebApp without inputting a website address, which enables the WebApp to achieve the operability and display effect same good as the NativeApp, while maintaining the advantages of good compatibility, convenience, and no need for installation.

It is to be noted that illustration is made above according to the division of the above-mentioned functional modules as to accessing the WebApp by the WebApp launch apparatus in accordance with the foregoing embodiments, and in practice, the above-mentioned functions can be assigned to be performed by different functional modules as required, i.e., dividing the internal structure of the device into different functional modules to perform all or some of the above-described functions. In addition, the method for launching WebApp provided by the above-mentioned embodiments belongs to a same concept, and its specific implementation process will not be repeated here.

The numbering of the above-mentioned embodiments is merely provided for the convenience of description. It does not imply any preference among the examples.

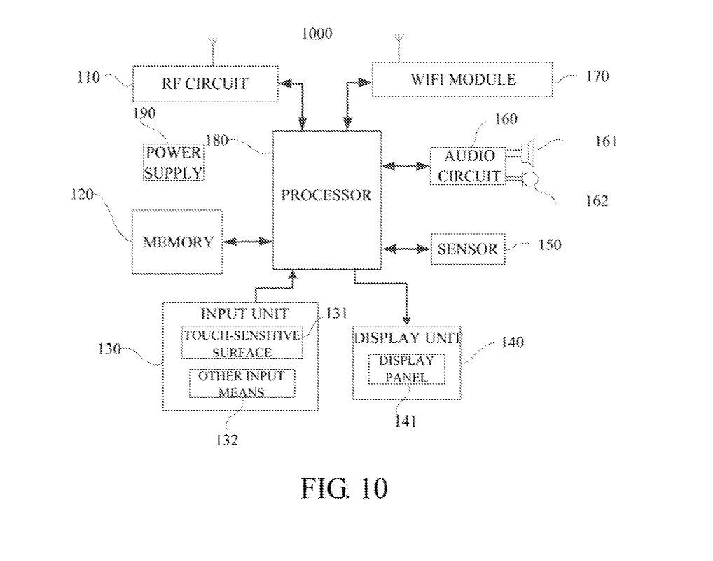

FIG. 10 is an exemplary structure diagram of a terminal device provided by an embodiment of the disclosure. The terminal device may be used to implement the WebApp launch method provided by the above-mentioned embodiments.

The terminal device 1000 may include components such as a Radio Frequency (RF) circuit 110, a memory 120 containing one or more computer readable storage medium, an input unit 130, a display unit 140, a sensor 150, an audio circuitry 160, a WiFi module 170, a processor 180 containing one or more processing cores, a power supply 190 and so on. As appreciated by those skilled in the art, the structure of the terminal device shown in FIG. 10 is not a limitation to the terminal device, the terminal device may contain more or less components than those shown in the figure, and some components may be combined or be arranged in separate components.

The RF circuit 110 is configured to receive and send signals during the process of receiving and transmitting information or during a calling communication. In particular, the RF circuit 110 receives downlink information from a base station and forwards it to the at least one or more processors 180. The RF circuit 110 also sends data involved in an uplink transmission to the base station. Typically, the RF circuit 110 may include, but not limited to, an antenna, at least one amplifier, a resonator, one or more oscillator, a Subscriber Identity Module (SIM) card, a transceiver, a coupler, a Low Noise Amplifier (LNA), a duplexer, and so on. In addition, the RF circuit 110 may communicate with the network and other devices via a wireless communication. The wireless communication may apply any of communication standards or protocols, including but not limited to Global System of Mobile communication (GSM), General Packet Radio Service (GPRS), Code Division Multiple Access (CDMA), Wideband Code Division Multiple Access (WCDMA), Long Term Evolution (LTE), email, Short Messaging Service (SMS), etc.

The memory 120 may be used for storing software programs and modules. The processor 180 executes a variety of functional applications and data processing by performing the software programs and modules stored in the memory 120. The memory 120 may mainly contain a program storage area and a data storage area. The program storage area may store operating system, application needed for realizing at least one function (e.g., sound playback function, image display function, etc.), and the data storage area may store the data created in accordance with the usage of the terminal device 1000 (e.g., audio data, telephone contact, etc.). The memory 120 may include high-speed Random Access Memory (RAM), and may also include a non-volatile memory, such as at least one magnetic disk storage device, flash memory device, or other non-volatile solid state storage device. Correspondingly, the memory 120 may also include a controller for the memory for providing access of the memory 120 to the processor 180 and the input unit 130.

The input unit 130 may be used for receiving inputted data or symbols information and generating signal inputs from keyboard, mouse, joystick, optic or trackball that relate to user settings and function control. Specifically, the input unit 130 may include a touch-sensitive surface 131 and another input device 132. The touch-sensitive surface 131, also called as touch screen or touch panel, may collect touch operations performed on or nearby the touch-sensitive surface by the user (for example, operations on or nearby the touch-sensitive surface 131 by the user using any suitable object or attachment, such as a finger, a stylus, etc.), and drive corresponding connected devices based on a predefined program. Optionally, the touch-sensitive surface 131 may include touch detection means and a touch controller. The touch detection means may detect user's touch position, identify a signal from the touch operation, and forward this signal to the touch controller. The touch controller may receive touch information from the touch detection means to transform to coordinates of the touch point and forward to the processor 180, and receives and executes instructions from processor 180. The touch-sensitive surface 131 may be implemented in variety manners such as resistive, capacitive, infrared and surface acoustic wave. In addition to the touch-sensitive surface 131, the input unit 130 may also include the other input device 132. Specifically, the other input device 132 may include, but not limited to, physical keyboard, functional keys (such as volume control buttons, switch buttons, etc.), a trackball, a mouse, a joystick, etc, or the combination thereof.

The display unit 140 may be used for displaying information inputted from the user or provided to the user and a variety of Graphic User Interface (GUI) of the terminal device 1000 which may be constituted by graphics, texts, icons, videos and any combination thereof. The display unit 140 may include display panel 141 which can be optionally implemented by forms like Liquid Crystal Display (LCD), Organic Light-Emitting Diode (OLED), etc. Furthermore, the touch-sensitive surface 131 may cover the display panel 141. When a touch operation has been detected by the touch-sensitive surface 131, the touch operation is transmitted to processor 180 to determine the type of this touch event, then the processor 180 provides corresponded visual output with the display panel 141 based on the type of the touch event. Though it is displayed in FIG. 10 that the touch-sensitive surface 131 and display panel 141 are two separated components that implementing the input and output functions respectively , but in some embodiments, the touch-sensitive surface 131 and display panel 141 can be integrated together to implemented the input and output functions.

The terminal device 1000 may also include at least one type of sensor 150 which may be optical sensor, motion sensor and other sensors. Specifically, the optical sensor may include ambient light sensor and proximity sensor, wherein the ambient light sensor may adjust the brightness of the display panel 141 based on the dimming and brightening of the environment, and the proximity sensor may close display panel 141 and backlight when the terminal device 1000 approaches user's ears. As one kind of motion sensor, the gravity accelerometer may detect accelerations in each direction and the weight and direction of the gravity when static. These features may be used for the application of identifying phone's gesture (for example, rotation switch, related games, the correction of gestures of the magnetometer), functions related to vibration recognition (e.g., pedometer, knock), etc.; other sensors that can be configured for terminal device 1000 such as gyroscope, barometer, hygrometer, infrared sensor will not be repeated herein.

The audio circuit 160, speaker 161, microphone 162 may be used to provide audio interfaces between the user and the terminal device 1000. The audio circuit 160 may receive audio data, transform it to electric signal, and transmit to the speaker 161 where the electric signal will be transformed to sound signal to output; on the other side, the microphone 162 will transform the collected sound signal to electric signal, this electric signal is transformed to audio data after received by the audio circuit 160, then the audio data will be sent to for example another terminal device via RF circuit 110, or stored in memory 120 for further processing, after processed by processor 180. Also, the audio circuit 160 may include earplug jack to support the communication between the peripherals headphones and the terminal device 1000.

WiFi belongs to short-range wireless transmission technology. Through the WiFi module 170, the terminal device 1000 may provide the user wireless broadband accessing such as emailing, web page browsing, and streaming media accessing, etc. Though the wireless module 170 is shown in FIG. 10, it can be understood that this unit can be omitted if necessary as it does not belong to essential component of the terminal device 1000.

The processor 180 is the controlling center of the terminal device 1000, which communicates with other components of the terminal device 1000 via a variety of interfaces and links. The processor 180 executes functions of the terminal device 1000 and processes data, by performing software programs and/or modules stored in the memory 120 and calling data stored in the memory 120. Optionally, the processor 180 may include one or more processing core. Preferably, a application processor and modem processor may be integrated in the processor 180, wherein the application processor is responsible for handling the operation system, user interface and application programs, etc., and the modem processor is mainly responsible for processing wireless communication. It is appreciated that said modem processor may also be separated from the processor 180.

Terminal device 1000 may also include power supply 190 to supply power to each component. Preferably, the power supply may be logically connected with the processor 180 via a power management system, and thus achieve functions such as charging, discharging and power consumption management via the power management system. The power supply 190 may also include any combination of components such as DC or AC power supply, Recharging system, failing detection circuit of the power supply, power transformer or inverter, power status indicator, etc.

The terminal device 1000 may also include a camera, a Bluetooth module, etc. not shown and not repeated herein. In particular, in this embodiment, the display unit of the terminal device may be a touch screen display, the terminal device may also include a memory and one or more programs, with the one or more programs stored in the memory and configured to be executed by one or more processors to perform the following operations: receiving an instruction from a user for launching a WebApp; acquiring and running HTML codes corresponding to the WebApp; acquiring a WebApp launch mode for the user from the HTML codes; running a meta label for full-screen launch in the HTML codes if the WebApp launch mode for the user is via a WebApp shortcut created previously on a main screen of a terminal, wherein, the meta label is used to indicate hiding a tool bar and a menu bar of a browser, and to scale the WebApp's frame to the same size as a screen of the terminal.

In accordance with another embodiment of the present disclosure, the memory may further store instructions configured to: set up a WebApp shortcut on the main screen of the terminal.

In accordance with another embodiment of the present disclosure, the memory may further store instructions configured to: send to the browser a request for the title of the browser; determine if the current browser is a predefined first browser based on the browser returned response message; set up a WebApp shortcut on the main screen of the terminal through the browser, when the browser is the predefined first browser; wherein the first browser is a browser capable of creating WebApp shortcut.

In accordance with another embodiment of the present disclosure, the memory may further store instructions configured to: read the flag in the local storage, the flag is used to identify whether it is the user's first time of accessing the WebApp; determine if it is the user's first time of accessing the WebApp based on the flag; prompt the user to create the WebApp shortcut on the main screen of the terminal when it is determined that it is the user's first time of accessing the WebApp.

In accordance with another embodiment of the present disclosure, the memory may further store instructions configured to: set the title, icon, display effect, etc, for the shortcut in the HTML codes.

In accordance with another embodiment of the present disclosure, the memory may further store instructions configured to: determine whether the HTML codes corresponding to the WebApp need to be updated.

In accordance with another embodiment of the present disclosure, the memory may further store instructions configured to: acquire the updated HTML codes via the corresponded website address of the WebApp and run the updated HTML codes when the HTML codes corresponding to the WebApp need to be updated; and read the HTML codes corresponding to the WebApp from the local storage and run the HTML codes corresponding to the WebApp when the HTML codes corresponding to the WebApp do not need to be updated.

In accordance with another embodiment of the present disclosure, the memory may further store instructions configured to: display the frame of the WebApp within the page region of the browser, based on the scaling control label preset in the HTML codes.

As another aspect of the disclosure, a computer readable storage medium is provided in another embodiment. This computer readable storage medium may be computer readable storage medium stored in the above-mentioned memory, or a component external to the terminal device. The computer readable storage medium has stored one or more programs which is executed by one or more processors to perform a WebApp launch method, the method including: receiving an instruction from a user for launching a WebApp; acquiring and running HTML codes corresponding to the WebApp; acquiring the WebApp launch mode for the user from the HTML codes; running a meta label for full-screen launch in the HTML codes if the WebApp launch mode for the user is via a WebApp shortcut created previously on a main screen of a terminal, wherein, the meta label is used to indicate hiding a tool bar and a menu bar of a browser, and to scale the WebApp's frame to the same size as a screen of the terminal.

Alternatively, the method further includes: creating a WebApp shortcut on the main screen of the terminal before receiving the instruction from the user for launching the WebApp.

Alternatively, the step of creating a WebApp shortcut on the main screen of the terminal includes: sending to the browser a request for the title of the browser; determining if the current browser is a predefined first browser based on the browser returned response message; creating a WebApp shortcut on the main screen of the terminal through the browser, when the browser is the predefined first browser; wherein the first browser is a browser capable of creating WebApp shortcut.

Alternatively, before the step of creating a WebApp shortcut on the main screen of the terminal through the browser, the method further includes: reading the flag in the local storage, the flag is used to identify whether it is the user's first time of accessing the WebApp; determining if it is the user's first time of accessing the WebApp based on the flag; prompting the user to create the WebApp shortcut on the main screen of the terminal when it is determined that it is the user's first time of accessing the WebApp.

Alternatively, before the step of creating a WebApp shortcut on the main screen of the terminal through the browser, the method further includes: setting the title, icon, display effect, etc, for the shortcut in the HTML codes.

Alternatively, the method further includes: determining whether the HTML codes corresponding to the WebApp need to be updated before acquiring and running the HTML codes corresponding to the WebApp.

Alternatively, the step of acquiring and running the HTML codes corresponding to the WebApp includes: acquiring the updated HTML codes via the corresponded website address of the WebApp and running the updated HTML codes when the HTML codes corresponding to the WebApp need to be updated; and reading the HTML codes corresponding to the WebApp from the local storage and running the HTML codes corresponding to the WebApp when the HTML codes corresponding to the WebApp do not need to be updated.

Alternatively, the method further includes: if the WebApp launch mode for the user is to access WebApp by inputting the website address through the browser, displaying the frame of the WebApp within the page region of the browser, based on the scaling control label preset in the HTML codes.

Those skilled in the art would appreciate that all or parts of steps of the above-mentioned embodiments can be implemented in the hardware, firmware, software or any combination thereof. These programs can be stored in a computer readable storage medium, which may be a Read Only Memory, a disk or an optical disk.

The disclosed embodiments are just some preferred embodiments of the disclosure, which are not intended to limit the disclosure. Any modification, equivalent or improvement within the spirits and principle of the disclosure shall be fall within the scope of the disclosure.

1. A WebApp launch method, comprising:
receiving an instruction from a user for launching a WebApp;
acquiring and running HTML codes corresponding to the WebApp;
acquiring a WebApp launch mode for the user from the HTML codes; and
running a meta label for full-screen launch in the HTML codes if the WebApp launch mode for the user is via a WebApp shortcut created previously on a main screen of a terminal, wherein the meta label is configured to indicate hiding a tool bar and a menu bar of a browser, and to scale the WebApp's frame to the same size as a screen of the terminal.

2. The method of claim 1, further comprising, prior to the step of receiving an instruction from a user for launching a WebApp:
creating a WebApp shortcut on the main screen of the terminal.

3. The method of claim 2, wherein the step of creating a WebApp shortcut on the main screen of the terminal comprises:
sending to the browser a request for the title of the browser; determining if the browser is a predefined first browser based on a response message returned by the browser; and
creating the WebApp shortcut on the main screen of the terminal through the browser if the browser is the predefined first browser,
wherein the first browser is a browser that supports creating shortcut for WebApp.

4. The method of claim 3, further comprising, prior to the step of creating a WebApp shortcut on the main screen of the terminal through the browser:
reading from a local storage a flag for identifying whether it is the user's first time of accessing the WebApp;
determining if it is the user's first time of accessing the WebApp based on the flag; and
prompting the user to create the WebApp shortcut on the main screen of the terminal if it is determined that it is the user's first time of accessing the WebApp.

5. The method of claim 2, further comprising, prior to the step of creating a WebApp shortcut on the main screen of the terminal:
setting title, icon and display effect for the shortcut in the HTML codes.

6. The method of claim 1, further comprising, prior to the step of acquiring and running the HTML codes corresponding to the WebApp:
determining whether the HTML codes corresponding to the WebApp need to be updated.

7. The method of claim 6, wherein the step of acquiring and running the HTML codes corresponding to the WebApp comprises:
acquiring updated HTML codes via a website address corresponding to the WebApp and running the updated HTML codes, if the HTML codes corresponding to the WebApp need to be updated; and
reading the HTML codes corresponding to the WebApp from the local storage and running the HTML codes corresponding to the WebApp, if the HTML codes corresponding to the WebApp do not need to be updated.

8. The method of claim 1, further comprising, if the WebApp launch mode for the user is to access the WebApp by inputting a website address through the browser:
displaying the frame of the WebApp within a page region of the browser based on a scaling control label preset in the HTML codes.

9. A WebApp launch apparatus, comprising:
a receiving module, configured to receive an instruction from a user for launching a WebApp;
a code acquisition module, configured to acquire and run HTML codes corresponding to the WebApp;
a launch mode acquisition module, configured to acquire a WebApp launch mode for the user from the HTML codes; and
a first running module, configured to run a meta label for full-screen launch in the HTML codes if the WebApp launch mode for the user is via a WebApp shortcut created previously on a main screen of a terminal,
wherein the meta label is configured to indicate hiding a tool bar and a menu bar of a browser, and to scale a frame of the WebApp to the same size as a screen of the terminal.

10. The apparatus of claim 9, further comprising:
a setup module, configured to create a WebApp shortcut on the main screen of the terminal before the receiving module receives the instruction from the user for launching the WebApp.

11. The apparatus of claim 10, wherein the setup module comprises:
a request unit, configured to send to the browser a request for a title of the browser;
a first determination unit, configured to determine if the browser is a predefined first browser based on the browser returned response message; and
a setup unit, configured to create the WebApp shortcut on the main screen of the terminal through the browser when the first determination unit determines that the browser is the predefined first browser,
wherein the first browser is a browser capable of creating WebApp shortcut.

12. The apparatus of claim 11, wherein the setup module further comprises:
a reading unit, configured to read a flag from a local storage before the setup unit sets up the WebApp shortcut on the main screen of the terminal through the browser, the flag identifying whether it is the user's first time of accessing the WebApp;
a second determination unit, configured to determine if it is the user's first time of accessing the WebApp based on the flag; and
a prompting unit, configured to prompt the user to create the WebApp shortcut on the main screen of the terminal if the second determination unit determines that it is the user's first time of accessing the WebApp;

13. The apparatus of claim 10, further comprising:
a shortcut setup module, configured to set title, icon and display effect for the shortcut in the HTML codes before the setup module creates the shortcut of the WebApp on the main screen of the terminal.

14. The apparatus of claim 9, further comprising:
a determination module, configured to determine whether the HTML codes corresponding to the WebApp need to be updated before the code acquisition module acquires and runs the HTML codes corresponding to the WebApp.

15. The apparatus of claim 14, wherein the code acquisition module comprises:
a first acquisition unit, configured to acquire updated HTML codes via a website address corresponding to the WebApp and run the updated HTML codes if the determination module determines that the HTML codes corresponding to the WebApp need to be updated; and
a second acquisition unit, configured to read the HTML codes corresponding to the WebApp from the local storage and run the HTML codes corresponding to the WebApp if the determination module determines that the HTML codes corresponding to the WebApp do not need to be updated.

16. The apparatus of claim 9, further comprising:
a second running module, configured to display the frame of the WebApp within a page region of the browser, based on a scaling control label preset in the HTML codes, if the WebApp launch mode for the user obtained by the launch mode acquisition module is to access WebApp by inputting a website address through the browser.

17. A non-transitory computer readable storage medium encoded with one or more executable instructions which, when executed by a processor, cause the processor to perform a method comprising:
receiving an instruction from a user for launching a WebApp;
acquiring and running HTML codes corresponding to the WebApp;
acquiring a WebApp launch mode for the user from the HTML codes; and
running a meta label for full-screen launch in the HTML codes if the WebApp launch mode for the user is via a WebApp shortcut created previously on a main screen of a terminal,
wherein the meta label is configured to indicate hiding a tool bar and a menu bar of a browser, and to scale the WebApp's frame to the same size as a screen of the terminal.
